(19) United States
(12) Patent Application Publication
(10) Pub. No.: US 2007/0124383 A1
(43) Pub. Date: May 31, 2007

(54) Multiple mail reducer

(76) Inventors: Cedric R.J. Hebert, Mouans Sartoux (FR); Laurent Y. Gomez, Le Cannet (FR); Cedric S.P. Ulmer, Nice (FR); Pascal T.C. Spadone, Meythet (FR)

Correspondence Address: PERKINS COIE LLP, 101 JEFFERSON DR, PO BOX 2168, MENLO PARK, CA, 94025, US

(21) Appl. No.: 10/547,496

(22) PCT Filed: Dec. 3, 2004
(86) PCT No.: PCT/IB04/03967

§ 371 Date: Aug. 31, 2005

(51) Int. Cl. G06F 15/16

(52) U.S. Cl. 709/206

(57) ABSTRACT

A technique for reducing multiple emails is described. In one embodiment, this involves checking mailing lists to which an email recipient subscribes. A method according to the technique includes receiving a message forwarding a forwarded message, comparing a recipient of the message to recipients of the forwarded message, and marking the message as a duplicate. A device developed according to the technique may include a processor and a memory. The memory may include a forward detection module configured to identify forwarded messages, a duplicate detection module configured to identify an intended recipient of a message as a subscriber to a distribution list from which the forwarded message originated, and a duplicate message modification module configured to mark a message forwarding the forwarded message.

### FIELD

The present invention relates to data processing systems, and specifically to processing of email in relation to duplicate email messages.

### BACKGROUND

Email has gone from a curiosity for university employees and students to a ubiquitous form of communication. It may be used by businesses as a primary form of communication, both internal and external. This potentially consumes huge amounts of resources. For example, data storage media of various forms may be filled with email. Moreover, some recipients of email print out each email received. While there may be good reasons for this, it potentially consumes vast resources in the form of paper, printer consumables (such as toner or ink for example), and power.

In an enterprise environment, an employee sometimes receives multiple copies of the same email. The email may be received first via a mailing list, then again as a forward from, for example, a line manager, and yet again as a forward from, for example, a project manager. Similarly, an employee may receive an email, then receive the email forwarded by various colleagues (whether subordinates, peers, managers, or organizationally unrelated). In time, the employee may have a great deal of redundant email stored in a mailbox, wasting space.

Some efforts have been made to reduce wasted space in a mailbox, such as by SPAM management. SPAM engines silently filter received emails according to rules associated with the SPAM folder of a recipient. This technique can remove redundant email, but it does not do so according to whether the email has already been received. Moreover, with SPAM management, it would be undesirable to provide information about the recipient of the email to the sender (potentially, a SPAMmer).

Another attempt to reduce wasted space in a mailbox involves comparing email content to reduce redundant parts of different emails. This leads to problems such as data loss. Also, the technique can be resource-intensive as the size of mailboxes increase.

Similarly, compression may be used to reduce the size of email in stored form. This potentially allows more email or other data to be stored in the data storage media involved. However, encryption and decryption are typically slow and resource intensive processes, thus requiring a tradeoff between data storage resources and other resources (such as time or processor power for example).

### SUMMARY

A technique for reducing multiple emails is described and illustrated in various embodiments in this document. In one embodiment, the technique involves checking mailing lists to which an email recipient subscribes. An example of a method according to the technique includes receiving a message, forwarding a forwarded message, comparing a recipient of the message to recipients of the forwarded message, and marking the message as a duplicate. In this example, the recipients of the forwarded message may include subscribers to a distribution list. The method may further include determining that the forwarded message originated from a distribution list. The method may further include querying a sender about sending the forward message. The method may also include relaying the message to the intended recipient.

An example of a device developed according to the technique may include a processor and a memory. The memory may include a forward detection module configured to identify forwarded messages, a duplicate detection module configured to identify an intended recipient of a message as a subscriber to a distribution list from which the forwarded message originated, and a duplicate message modification module configured to mark a message forwarding the forwarded message.

In some embodiments, the device may further include a distribution list manager, which may or may not include a distribution list server or a list of subscribers to the distribution list from which the forwarded message originated. In another embodiment, the device may include a query generator configured to query a sender of the forwarded message as to whether to send the forwarded message even though the forwarded message has probably already been received by the intended recipient. In other embodiments, the device may include a mail server.

### BRIEF DESCRIPTION OF THE DRAWINGS

Embodiments of the invention are illustrated in the figures. However, the embodiments and figures are illustrative rather than limiting; they provide examples of the invention. The invention is limited only by the claims.

FIG. 1 depicts a system for reducing multiple emails according to an embodiment.

FIG. 2 depicts a flowchart of a method for marking redundant emails in a system according to an embodiment.

FIG. 3 depicts a flowchart of a method for filtering redundant emails in a system according to an embodiment.

FIG. 4 depicts a system for reducing multiple emails according to another embodiment.

FIG. 5 depicts a flowchart of a method for marking redundant emails in a system according to an embodiment.

FIG. 6 depicts a flowchart of a method for filtering redundant emails in a system according to an embodiment.

FIG. 7 depicts a system for reducing multiple emails according to another embodiment.

FIG. 8 depicts a flowchart of a method for forwarding redundant emails in a system according to an embodiment.

FIG. 9 depicts a flowchart of a method for marking redundant emails in a system according to an embodiment.

FIG. 10 depicts a networked system for use in an embodiment.

FIG. 11 depicts a computer system for use in the system of FIG. 10.

FIG. 12 depicts an example of an email transaction according to an embodiment.

FIGS. 13A, 13B, and 13C depict header information associated with the email transaction of FIG. 12.

### DETAILED DESCRIPTION

A technique for reducing multiple emails is described and illustrated in various embodiments in this document. In one embodiment, the technique involves checking mailing lists to which an email recipient subscribes. An example of a method according to the technique includes receiving a message, forwarding a forwarded message, comparing a recipient of the message to recipients of the forwarded message, and marking the message as a duplicate. In this example, the recipients of the forwarded message may include subscribers to a distribution list. The method may further include determining that the forwarded message originated from a distribution list. The method may further include querying a sender about sending the forward message. The method may also include relaying the message to the intended recipient.

An example of a device developed according to the technique may include a processor and a memory. The memory may include a forward detection module configured to identify forwarded messages, a duplicate detection module configured to identify an intended recipient of a message as a subscriber to a distribution list from which the forwarded message originated, and a duplicate message modification module configured to mark a message forwarding the forwarded message.

In some embodiments, the device may further include a distribution list manager, which may or may not include a distribution list server or a list of subscribers to the distribution list from which the forwarded message originated. In another embodiment, the device may include a query generator configured to query a sender of the forwarded message as to whether to send the forwarded message even though the forwarded message has probably already been received by the intended recipient. In other embodiments, the device may include a mail server.

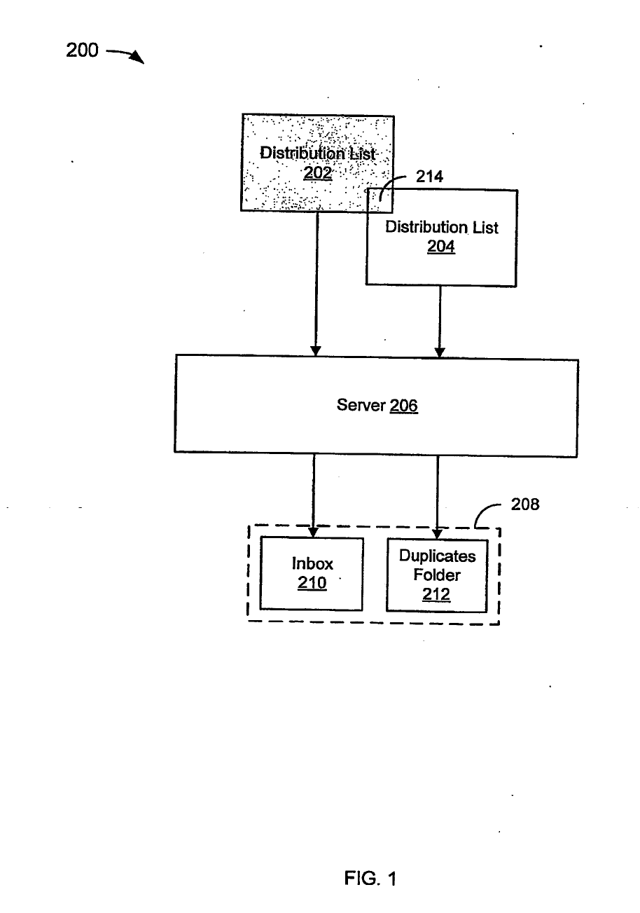

FIG. 1 depicts a system 200 for reducing multiple emails according to an embodiment. The system 200 includes a distribution list 202, a distribution list 204, a server 206, and a computer system 208. The computer system 208 includes an inbox 210 and a duplicates folder 212.

The distribution list 202 and distribution list 204 may have an overlap 214. The overlap 214 may occur when mail distributed from the distribution list 202 is the same as mail distributed from distribution list 204. The overlap 214 may be referred to as an email cross-point for the distribution lists 202, 204. If an entity, such as a person associated with the computer system 208, subscribes to both of the distribution lists 202, 204, email that is in the email cross-point may be redundantly distributed to the computer system 208.

The server 206 may include a mail server that receives mail and relays the mail on to the computer system 208. The server 206 may, for example, check an internal repository of names (not shown) before relaying mail to an intended recipient. If the intended recipient is in the internal repository, and would receive the same email twice, the server 206 may mark the mail as a duplicate. For example, when mail is sent to the intended recipient who, for the purposes of this example, is a member of both distribution lists 202, 204, one of the email messages can be marked as a duplicate.

When marking a duplicate, the server 206 may modify the header of one of the email messages to include the word “duplicate”, “Dup:”, or some other designation. In another embodiment, the server 206 distinguishes the email messages without comparing the email content. Rather, the server 206 checks a member's mailing list subscriptions to make the determination. In another embodiment, the server 206 sends both email messages on to the client. In alternative embodiments, the server 206 may delete duplicate messages (with or without first marking the message as a duplicate), delete the body of the message and send the header, replace the body of the message (or a portion of the message) with a link to duplicate content, compress duplicates, divert the duplicate message, block the duplicate message, or perform some other action in response to detecting a duplicate message.

The computer system 208 receives the messages from the server 206. Assuming the server 206 is configured to mark duplicate messages, the computer system 208 can be configured to recognize the mark. For example, if the server 206 changes the header of a duplicate email message to include the word “Dup:”, the computer system 208 can check the header for the word and treat the email message accordingly.

In an embodiment, the computer system 208 includes mail filtering rules. Normally, email messages are put into the inbox 210 upon receipt. Messages that include a mark indicating the message is a duplicate are filtered into a duplicates folder 212. Email messages may be placed in any folder, automatically deleted, forwarded, or otherwise managed. Accordingly, it is to be understood that none, some, or all email messages may be filtered into the inbox 210 or duplicate folder 212, depending upon the filtering rules. For example, some email messages may go to a “personal folder” (not shown) instead of the inbox 210. As another example, some email messages marked as duplicates could be automatically deleted. Thus, the inbox 210 and the duplicate folder 212 depicted in FIG. 1 are for illustrative purposes only.

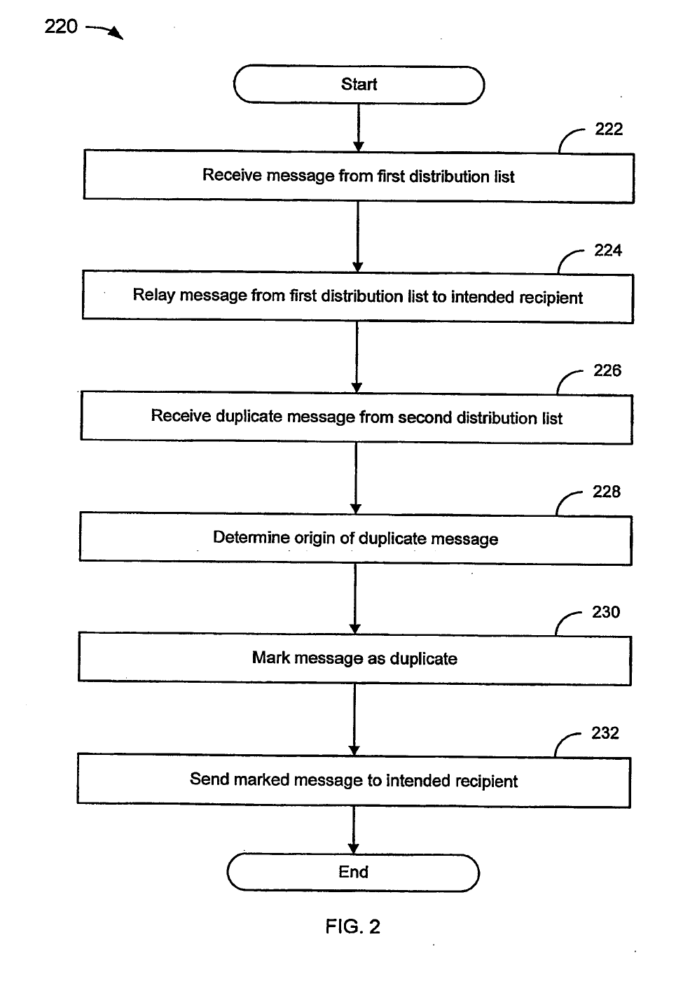

FIG. 2 depicts a process 220 of a method for marking redundant emails in a system such as the system 200 (FIG. 1). The example of FIG. 2 is intended to illustrate a method that may be implemented at a server, such as the server 206 (FIG. 1). The process 220 begins at module 222 with receiving a message from a first distribution list. The message may be, for example, an email message. The first distribution list may be, for example, the distribution list 202 (FIG. 1).

In an embodiment, the process 220 continues at module 224 with relaying the message from the first distribution list to an intended recipient. The email message may or may not be checked to determine whether it is a duplicate email message. The message may be relayed according to standard email routing protocols. In an embodiment, the intended recipient may be identified in, for example, the “To:” field of a message. In another embodiment, the intended recipient may be identified by determining which recipients are associated with a distribution list in, for example, the “To:” field of a message.

In an embodiment, the process 220 continues at module 226 with receiving a duplicate message from a second distribution list. The second distribution list may be, for example, the distribution list 204 (FIG. 1). The message is presumed, for the purposes of this example, to be a duplicate. The determination of whether the message is a duplicate may be made at, for example, the server 206. In an alternative embodiment, the determination of whether the message is a duplicate could be made prior to receipt at the server 206. For example, it may be determined that the intended recipient is a member of both lists and messages from the second distribution list are automatically marked as duplicates.

In an embodiment, the process 220 continues at module 228 with determining the origin of the duplicate message. In this example, the origin of the duplicate message is the second distribution list. The duplicate message may be from an email cross-point of the first and second distribution lists, with which the intended recipient of the duplicate message is associated. By checking the distribution lists with which the intended recipient is associated, and determining the origin of the duplicate message, the duplicate message can be identified as a duplicate. In an embodiment, the determination of origin may be made for each message, including the message received from the first distribution list. In another embodiment, the determination of origin is made once for both the message from the first distribution list and the message from the second distribution list.

In an embodiment, the process 220 continues at module 230 with marking the message as a duplicate. For example, the subject line of an email message could be modified to include a designation such as, “Dupl.:”. The precise mark used in marking the message or the location of the mark in the message (e.g., in the header, the body, or some other location) is not critical, so long as the message can later be identified as a duplicate using the mark.

In an embodiment, the process 220 ends at module 232 with sending the marked message to the intended recipient. The marked message may be relayed according to standard email routing protocols. Since the message is a duplicate, the marked message should be associated with the same intended recipient as the message from the first distribution list.

This method and other methods are depicted as serially arranged modules. However, modules of the methods may be reordered, or arranged for parallel execution or operation as appropriate. Moreover, the modules may be process modules, or may be apparatus components operating to execute the process.

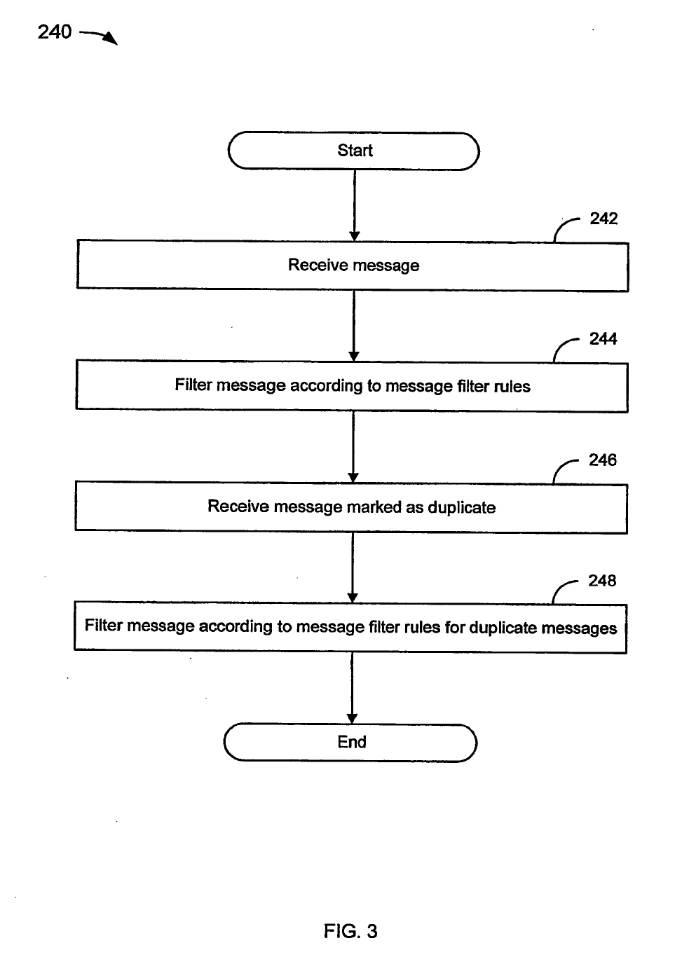

FIG. 3 depicts a process 240 of a method for filtering redundant emails in a system such as the system 200 (FIG. 1). The example of FIG. 3 is intended to illustrate a method that may be implemented by an intended recipient, for example at the computer system 208 (FIG. 1). The process 240 beings at module 242 with receiving a message. The message may be a non-redundant message, such as a message relayed as described with reference to module 224 (FIG. 2), or a redundant message, such as a message sent as described with reference to module 232 (FIG. 2).

In an embodiment, the process 240 continues at module 244 with filtering the message according to message filter rules. A duplicate message may be marked in such a way that message filter rules can identify the duplicate message as redundant. In this case, the duplicate message can be disposed of according to the rules by, for example, deleting the duplicate message or filtering the duplicate message into a duplicates folder, such as the duplicates folder 212 (FIG. 1). In an embodiment, duplicates could be filtered according to message filtering rules in much the same manner as any other message is filtered. Indeed, in another embodiment, duplicate emails could be put in an inbox, or a sub-division of an inbox, instead of a duplicates folder.

Non-redundant messages, or messages that the message filter rules fail to identify as redundant messages, may be filtered as desired according to well-known techniques. For the purposes of example, the non-redundant messages may be referred to as being put in an inbox, such as the inbox 210 (FIG. 1). It is to be understood that the term inbox is used for the purposes of example only and messages may be put into any location depending upon the applicable filtering rules.

In an embodiment, the process 240 continues at module 246 with receiving a message marked as duplicate. The process 240 ends at module 248 with filtering the message according to message filter rules for duplicate messages. In this embodiment, duplicate messages are filtered according to a filtering rule specifically directed to the duplicate messages. For example, the filtering rule could send all messages that include the words “DPL: ” in the subject line to a duplicates folder.

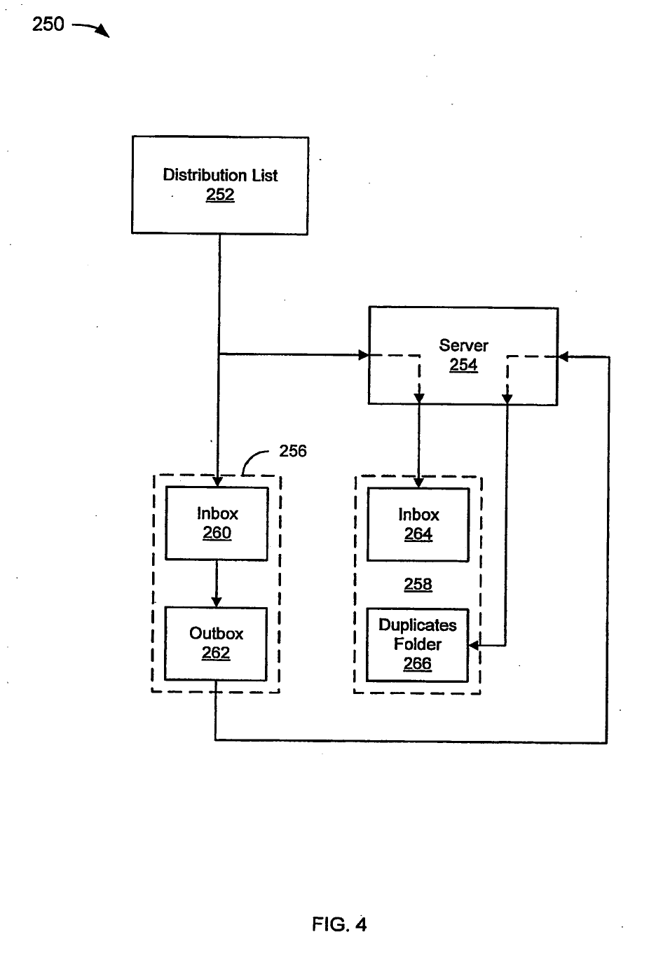

FIG. 4 depicts a system 250 for reducing multiple emails according to another embodiment. The system 250 includes a distribution list 252, a server 254, a computer system 256, and a computer system 258. The computer system 256 includes an inbox 260 and an outbox 262. The computer system 258 includes an inbox 264 and a duplicates folder 266.

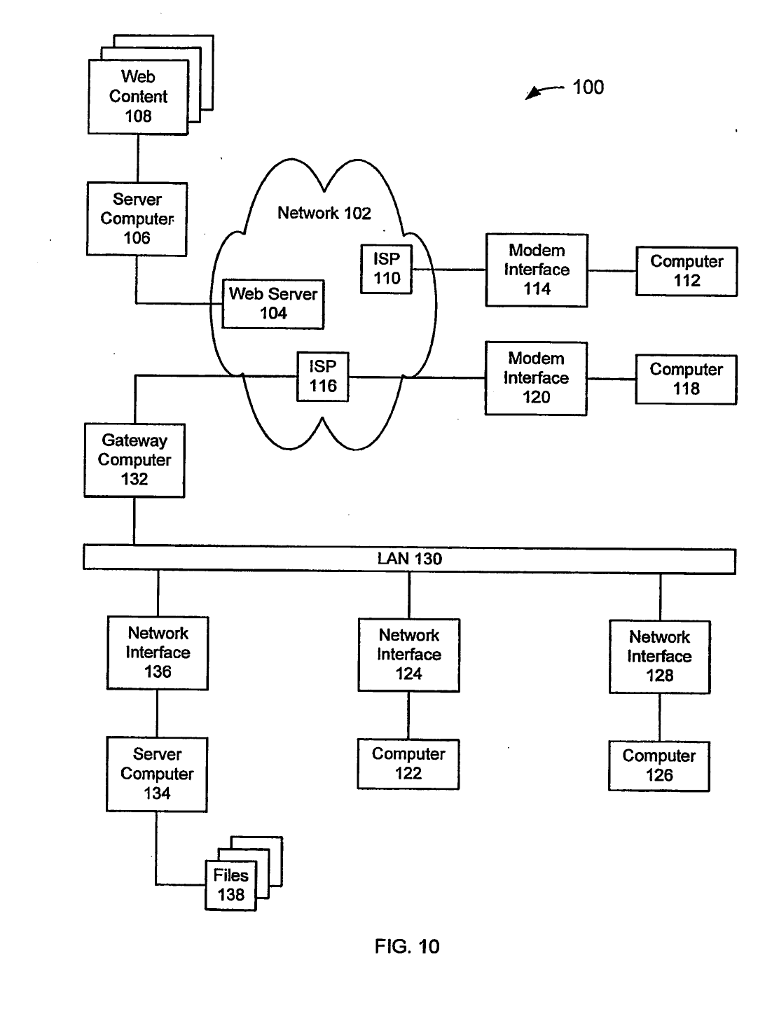

The distribution list 252, which may be implemented on another computer system (not shown), distributes messages, such as email messages, files, or other packets of data, to members. For the purposes of example, two of the members are associated with the computer systems 256 and 258. Intervening routing and other components between the distribution list and the computer systems 256 and 258 has been omitted, but is described later with reference to FIG. 10.

Though the distribution list 252 and the server 254 appear to be distinct, as depicted in FIG. 4, this is not a requirement. A server computer system could include both a distribution list server for the distribution list 252 and a mail server, such as the server 254. Moreover, the computer systems 256 and 258 could both be served by the server 254, though the server 254 is depicted in FIG. 4 as serving only the computer system 258.

In operation, in an embodiment, the distribution list 252 distributes a message to the server 254, which relays the message to the inbox 264 of the computer system 258. The distribution list 252 also distributes the message to the inbox 260 of the computer system 256. The computer system 256 then forwards the message from the outbox 262 to the server 254. The server determines that the member associated with the computer system 258 is on the distribution list 252 and marks the forwarded message as a duplicate. The computer system 258, upon receipt of the duplicate message, filters the duplicate message into the duplicates folder 266.

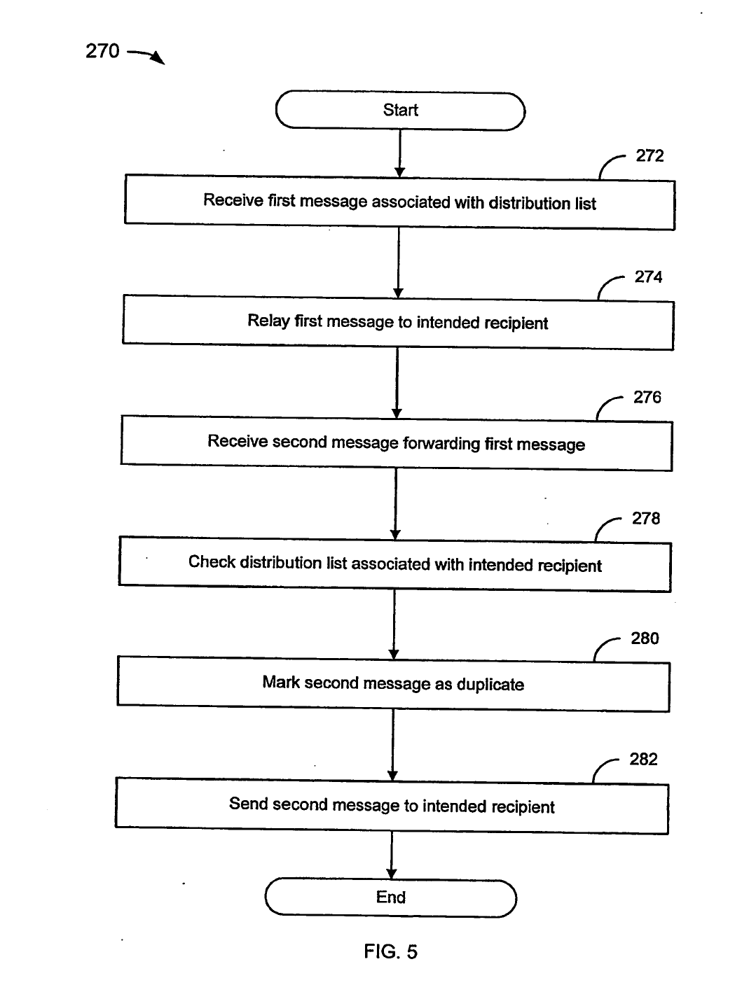

FIG. 5 depicts a process 270 of a method for marking redundant emails in a system such as the system 250 (FIG. 4). The example of FIG. 5 is intended to illustrate a method that may be implemented at a server, such as the server 254 (FIG. 4). The process 270 begins at module 272 with receiving a first message associated with a distribution list. The distribution list may be, for example, the distribution list 252 (FIG. 4).

In an embodiment, the process 270 continues at module 274 with relaying the first message to its intended recipient. The distribution list may or may not be checked to determine whether the message is a duplicate.

In an embodiment, the process 270 continues at module 276 with receiving a second message forwarding the first message. The second may be forwarding the first message because, for example, a first person associated with the distribution list forwards the first message to a second person. If the second person is also associated with the distribution list, the second message may be forwarding a message the second person has already received.

In an embodiment, the process 270 continues at module 278 with checking the distribution list associated with the intended recipient. This may include checking distribution lists associated with the intended recipient or, in an alternative embodiment, checking recipients associated with the distribution list from which the forwarded message was distributed. The check may entail querying a distribution list server associated with the distribution list to determine whether the intended recipient is associated with the distribution list.

In an embodiment, the process 270 continues at module 280 with marking the second message as a duplicate. In an embodiment, the process 270 ends with sending the second message to the intended recipient.

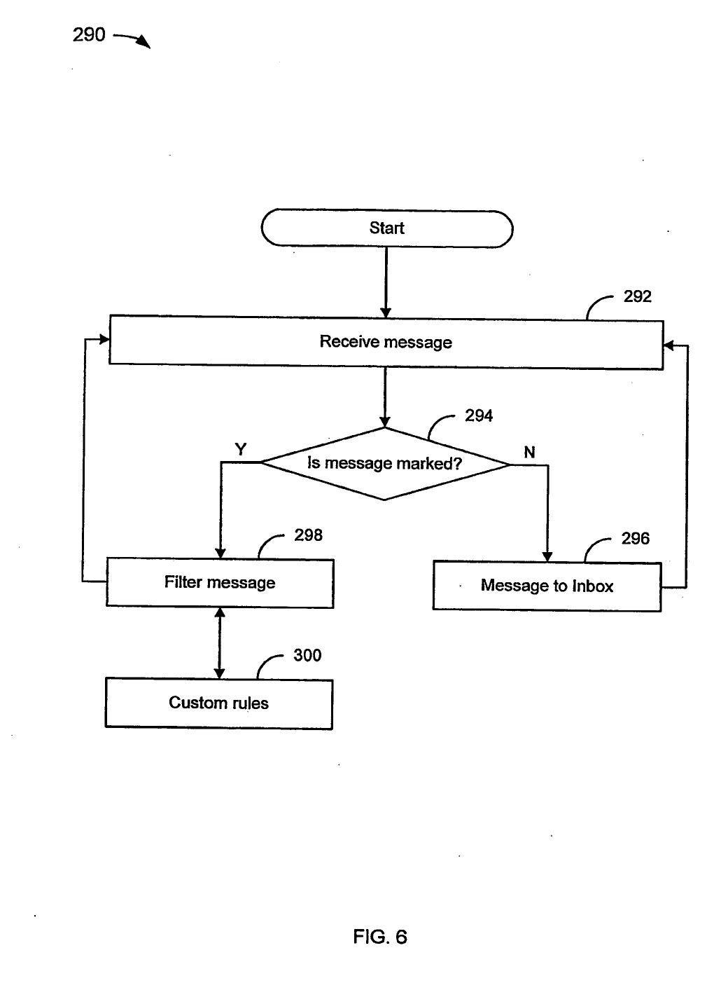

FIG. 6 depicts a process 240 of a method for filtering redundant emails in a system such as the system 250 (FIG. 4). The example of FIG. 6 is intended to illustrate a method that may be implemented by an intended recipient, for example at the computer system 258 (FIG. 4).

In an embodiment, the process 290 starts at module 292 with receiving a message. In an embodiment, the process 290 continues at decision point 294 with determining whether the message is marked.

If the message is not marked (294-N), then, in an embodiment, the process 290 continues at module 296 with putting the message in an inbox, then the process 290 continues from module 292, as described previously. In an alternative embodiment, the message is not put in an inbox but, rather, is routed or disposed of according to message filtering rules.

If the message is marked (294-Y), then, in an embodiment, the process 290 continues at module 298 with filtering the message. This may involve invoking custom rules at module 300. In any case, the message may be filtered to a duplicates folder, deleted, forwarded, or otherwise redirected or disposed of Then, the process 290 continues from module 292.

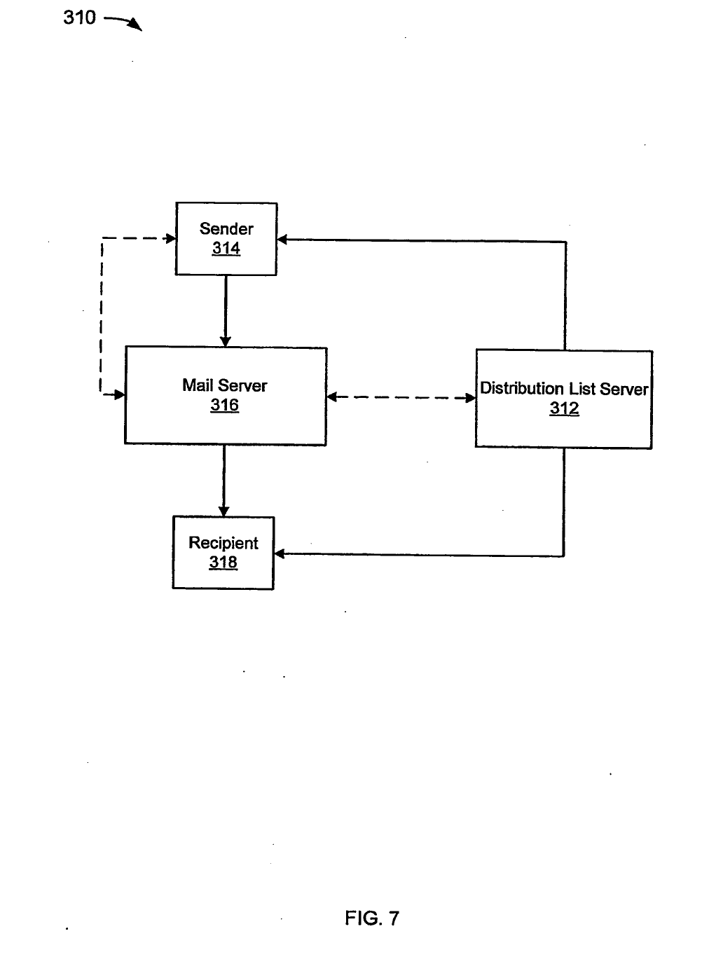

FIG. 7 depicts a system 310 for reducing multiple emails according to another embodiment. The system 310 includes a distribution list server 312, a computer system 314, a mail server 316, and a computer system 318. In operation, a message is distributed from the distribution list server 312 to the computer system 314 (referred to hereinafter as the sender) and the computer system 318 (referred to hereinafter as the recipient). The sender then forwards the message to the recipient. Since the distribution list server 312 has already distributed the message to the recipient, the forwarded message is redundant.

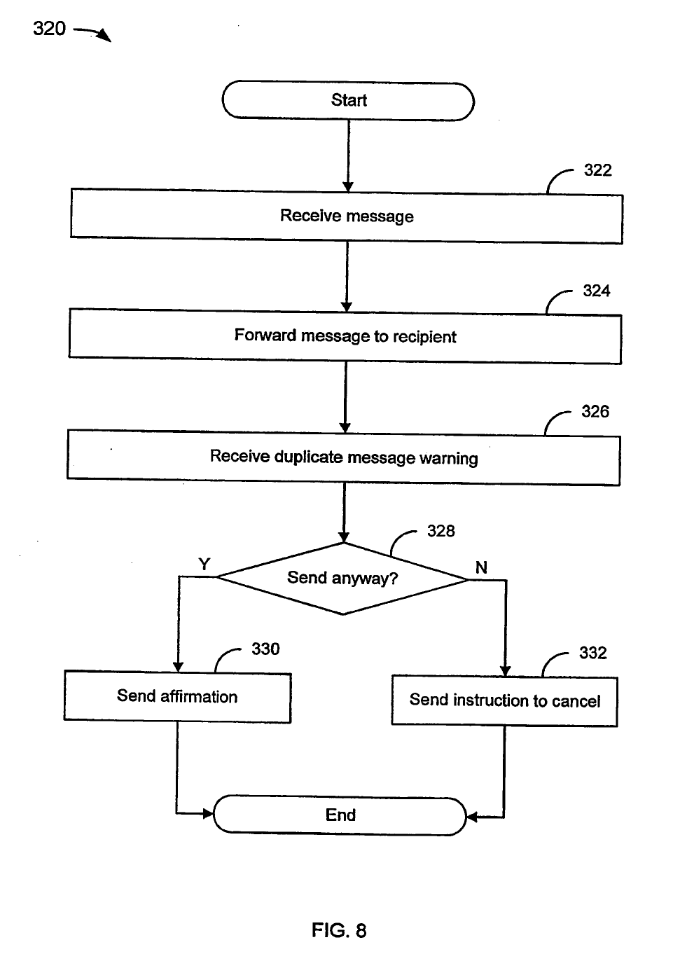

FIG. 8 depicts a process 320 of a method for forwarding redundant emails in a system such as the system 310 (FIG. 7). The example of FIG. 8 is intended to illustrate a method that may be implemented at a sender's computer system. In an embodiment, the process 320 starts at module 322 with receiving a message.

In an embodiment, the process 320 continues at module 324 with forwarding the message to a recipient. The message is typically relayed in part by, for example, a mail server, such as the mail server 316 (FIG. 7). In this example, the mail server 316 is aware that the message is redundant and may so warn the sender.

In an embodiment, the process 320 continues at module 326 with receiving a duplicate message warning from, for example, the mail server 316 (FIG. 7). The duplicate message warning may be, for example, an interactive popup message.

In an embodiment, the process 320 continues at decision point 328 with determining whether to send the redundant message anyway. For example, the sender may decide not to send a redundant message, or the sender may decide to send the redundant message. In an alternative embodiment, the decision about whether to send the redundant message is decided by a software or hardware agent.

If the message is to be sent even though it is redundant (328-Y), then the process 320 ends at module 330 with sending an affirmation. If the message is not to be sent (328-N), then the process 320 ends at module 332 with sending an instruction to cancel the redundant message.

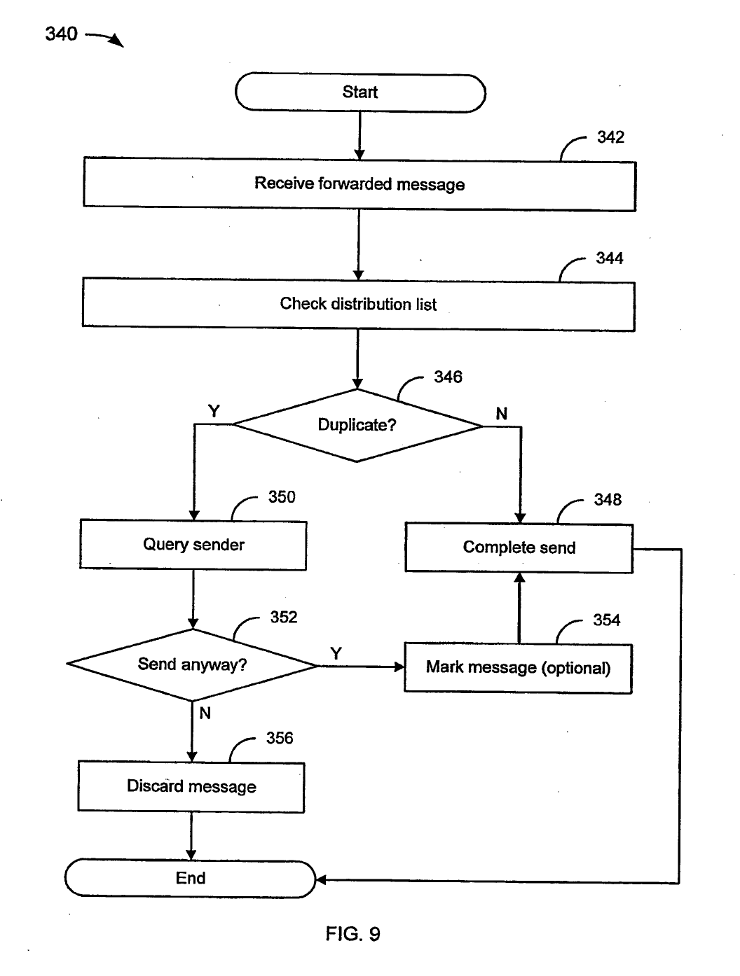

FIG. 9 depicts a process 340 of a method for marking redundant emails in a system such as the system 310 (FIG. 7). The example of FIG. 8 is intended to illustrate a method that may be implemented at a mail server, such as the mail server 316 (FIG. 7). In an embodiment, the process 340 starts at module 342 with receiving a forwarded message. The message may have been forwarded by a sender who is a member of a distribution list, for example.

In an embodiment, the process 340 continues at module 344 with checking a distribution list. The distribution list may include both the sender and the intended recipient of the forwarded message. Checking the distribution list may entail checking a server, such as the distribution list server 312 (FIG. 7) to determine whether one or both of the sender and intended recipient are associated with the distribution list.

In an embodiment, the process 340 continues at decision point 346 with determining whether the message is a duplicate. In an embodiment, the determination is message-specific, but only checks header information and distribution lists, not message contents. In an alternative embodiment, the message contents may be partially compared to find identifying information, such as a distribution list-specific identifier, within the body of the message.

If it is determined that the message is not a duplicate (346-N), the process 340 ends at module 348 with completing the send. In this case, the forwarded message is sent to the intended recipient without marking the forwarded message as a duplicate.

If it is determined that the message is a duplicate (346-Y), the process 340 continues at module 350 with querying the sender. The query may result in, for example, a popup window opening on a display of the sender's computer system. In another example, the query may be an email message to which the sender responds. Any number of querying techniques can be used, so long as the technique facilitates a response from the sender regarding how to dispose of the redundant message. When the sender responds to the query, it can be determined how to dispose of the message.

In an embodiment, the process 340 continues at decision point 352 with determining whether to send anyway. The determination may be made according to the response to the query from the sender, in addition to, other factors.

If it is determined that the message should be sent even though the message is redundant for the intended recipient (352-Y), the message is optionally marked as a duplicate at module 354, and the process ends with completing the send at module 348. If it is determined that the message should not be sent (352-N), the process 340 ends at module 356 with discarding the message.

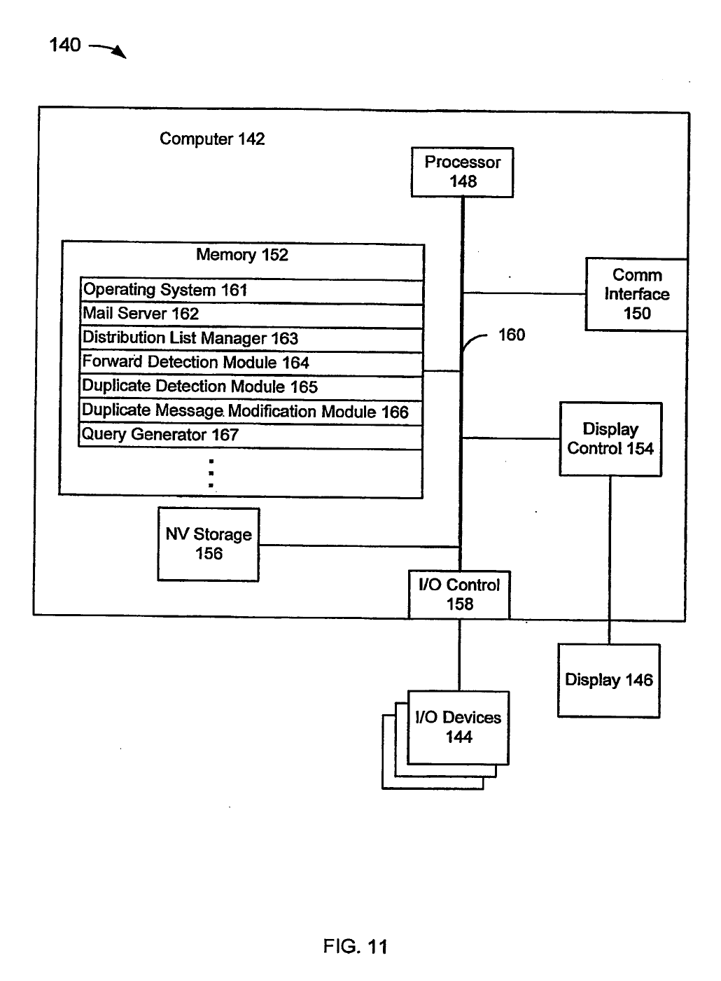

The following description of FIGS. 10 and 11 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 10 depicts a networked system 100 that includes several computer systems coupled together through a network 102, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 104 is typically at least one computer system which operates as a server computer system and is configured to operate with the protocols of the world wide web and is coupled to the Internet. The web server system 104 can be a conventional server computer system. Optionally, the web server 104 can be part of an ISP which provides access to the Internet for client systems. The web server 104 is shown coupled to the server computer system 106 which itself is coupled to web content 108, which can be considered a form of a database. While two computer systems 104 and 106 are shown in FIG. 10, the web server system 104 and the server computer system 106 can be one computer system having different software components providing the web server functionality and the server functionality provided by the server computer system 106, which will be described further below.

Access to the network 102 is typically provided by Internet service providers (ISPs), such as the ISPs 110 and 116. Users on client systems, such as client computer systems 112, 118, 122, and 126 obtain access to the Internet through the ISPs 110 and 116. Access to the Internet allows users of the client computer systems to exchange information, receive and send e-mails, and view documents, such as documents which have been prepared in the HTML format. These documents are often provided by web servers, such as web server 104, which are referred to as being “on” the Internet. Often these web servers are provided by the ISPs, such as ISP 110, although a computer system can be set up and connected to the Internet without that system also being an ISP.

Client computer systems 112, 118, 122, and 126 can each, with the appropriate web browsing software, view HTML pages provided by the web server 104. The ISP 110 provides Internet connectivity to the client computer system 112 through the modem interface 114, which can be considered part of the client computer system 112. The client computer system can be a personal computer system, a network computer, a web TV system, or other computer system. While FIG. 10 shows the modem interface 114 generically as a “modem,” the interface can be an analog modem, isdn modem, cable modem, satellite transmission interface (e.g. “direct PC”), or other interface for coupling a computer system to other computer systems.

Similar to the ISP 114, the ISP 116 provides Internet connectivity for client systems 118, 122, and 126, although as shown in FIG. 10, the connections are not the same for these three computer systems. Client computer system 118 is coupled through a modem interface 120 while client computer systems 122 and 126 are part of a LAN 130.

Client computer systems 122 and 126 are coupled to the LAN 130 through network interfaces 124 and 128, which can be ethernet network or other network interfaces. The LAN 130 is also coupled to a gateway computer system 132 which can provide firewall and other Internet-related services for the local area network. This gateway computer system 132 is coupled to the ISP 116 to provide Internet connectivity to the client computer systems 122 and 126. The gateway computer system 132 can be a conventional server computer system.

Alternatively, a server computer system 134 can be directly coupled to the LAN 130 through a network interface 136 to provide files 138 and other services to the clients 122 and 126, without the need to connect to the Internet through the gateway system 132.

FIG. 11 depicts a computer system 140 for use in the system 100 (FIG. 10). The computer system 140 may be a conventional computer system that can be used as a client computer system or a server computer system or as a web server system. Such a computer system can be used to perform many of the functions of an Internet service provider, such as ISP 110 (FIG. 10).

The computer system 140 includes a computer 142, I/O devices 144, and a display device 146. The computer 142 includes a processor 148, a communications interface 150, memory 152, display controller 154, non-volatile storage 156, and I/O controller 158. The computer system 140 may be coupled to or include the I/O devices 144 and display device 146.

The computer 142 interfaces to external systems through the communications interface 150, which may include a modem or network interface. It will be appreciated that the communications interface 150 can be considered to be part of the computer system 140 or a part of the computer 142. The communications interface can be an analog modem, ISDN modem, cable modem, token ring interface, satellite transmission interface (e.g. “direct PC”), or other interfaces for coupling a computer system to other computer systems.

The processor 148 may be, for example, a conventional microprocessor such as an Intel Pentium microprocessor or Motorola power PC microprocessor. The memory 152 is coupled to the processor 148 by a bus 160. The memory 152 can be dynamic random access memory (DRAM) and can also include static ram (SRAM). In an embodiment, the memory 152 includes an operating system 161, a mail server 162, a distribution list manager 163, a forward detection module 164, a duplicate detection module 165, a duplicate message modification module 166, and a query generator 167. It should be noted that the contents of the memory 152 in this example are most applicable to a server computer, rather than a client computer, though a computer system could serve as both. The bus 160 couples the processor 148 to the memory 152, also to the non-volatile storage 156, to the display controller 154, and to the I/O controller 158.

The I/O devices 144 can include a keyboard, disk drives, printers, a scanner, and other input and output devices, including a mouse or other pointing device. The display controller 154 may control in the conventional manner a display on the display device 146, which can be, for example, a cathode ray tube (CRT) or liquid crystal display (LCD). The display controller 154 and the I/O controller 158 can be implemented with conventional well known technology.

The non-volatile storage 156 is often a magnetic hard disk, an optical disk, or another form of storage for large amounts of data. Some of this data is often written, by a direct memory access process, into memory 152 during execution of software in the computer 142. One of skill in the art will immediately recognize that the terms “machine-readable medium” or “computer-readable medium” includes any type of storage device that is accessible by the processor 148 and also encompasses a carrier wave that encodes a data signal.

The computer system 140 is one example of many possible computer systems which have different architectures. For example, personal computers based on an Intel microprocessor often have multiple buses, one of which can be an I/O bus for the peripherals and one that directly connects the processor 148 and the memory 152 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 152 for execution by the processor 148. A Web TV system, which is known in the art, is also considered to be a computer system according to the present invention, but it may lack some of the features shown in FIG. 11, such as certain input or output devices. A typical computer system will usually include at least a processor, memory, and a bus coupling the memory to the processor.

The computer system 140 is controlled by the operating system software 161, which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 156 and causes the processor 148 to execute the various acts required by the operating system to input and output data and to store data in memory, including storing files on the non-volatile storage 156.

The mail server 162 includes software to relay email messages from a sender to a recipient. Typically, email and other electronic communications are routed through multiple machines. The mail server 162 may serve multiple recipients. Senders and recipients may be served by the same mail server 162.

The distribution list manager 163 may be a distribution list server. A distribution list server typically sends email to multiple subscribers of a particular mailing list. In an embodiment, the mail server 162 communicates with the distribution list manager 163 to determine which subscribers belong to which distribution list. In an embodiment, the distribution list manager 163 includes a “currently subscribed mailing-lists” list for each user served by the mail server 162. The list may also include users served by other mail servers (not shown). The list could be determined dynamically from the information used to distribute mail from the mailing lists, users could register by providing the mailing lists to which they subscribe, or some other agent could enter subscriber information.

The forward detection module 164 checks email that is marked forwarded. Typically, such mail includes “Fwd:” in the subject line, though forwarded mail could be marked by various means. For example, the forward detection module 164 could be used to detect internally forwarded email with “IFwd:” in the subject line. The forward detection module 164 may incorporate other rules, such as mail filtering rules. The rules may include, for example, custom or company rules. In an alternative, the forward detection module 164 could detect messages that are not marked forwarded, using some other technique, such as checking the subject line for a particular subject.

The duplicate detection module 165 may determine which forwarded email is suspected to be a duplicate. In an embodiment, the duplicate detection module 165 only checks email that has been forwarded. In an alternative, the duplicate detection module 165 may be set to attempt to detect duplicates for all or some subset of email, even if not marked forwarded.

The duplicate detection module 165 may check the origin of a message to determine whether the message is originally from a distribution list. Then, the duplicate detection module 165 may consult a distribution list manager to determine whether the intended recipient of a forwarded message is a subscriber of the distribution list. In an embodiment, if the intended recipient of email that originated from a distribution list to which the intended recipient subscribes, the duplicate detection module 165 assumes the email is a duplicate message.

It should be noted that the duplicate detection module 165 does not check the body of the message, just the header information. In an embodiment, the duplicate detection module 165 may verify a prediction by checking the message body as well.

The duplicate message modification module 166 may mark a message as duplicate by, for example, inserting “Dup:” in the subject line. Alternatively, the duplicate message modification module 166 may replace “Fwd:” with “Dup:”. In other embodiments, the duplicate message modification module 166 may mark a message as a duplicate in some other manner. In an alternative, the sender may mark a message as a duplicate when responding to a query from the query generator 166. In this alternative, the duplicate message modification module 166 may not be required.

The query generator 167 generates a query for a sender after the duplicate detection module 165 detects a duplicate. In an embodiment, the query prompts a sender, using a popup window, to provide instructions regarding the message. The sender may, for example, reply to the query with “send anyway” if the sender doesn't mind sending a duplicate as a reminder, or for some other reason. For example, the duplicate detection module 165 could be wrong about the message being a duplicate. The sender may instead reply to the query with “do not send”, in which case the mail server 162 will not relay the duplicate message to the intended recipient.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

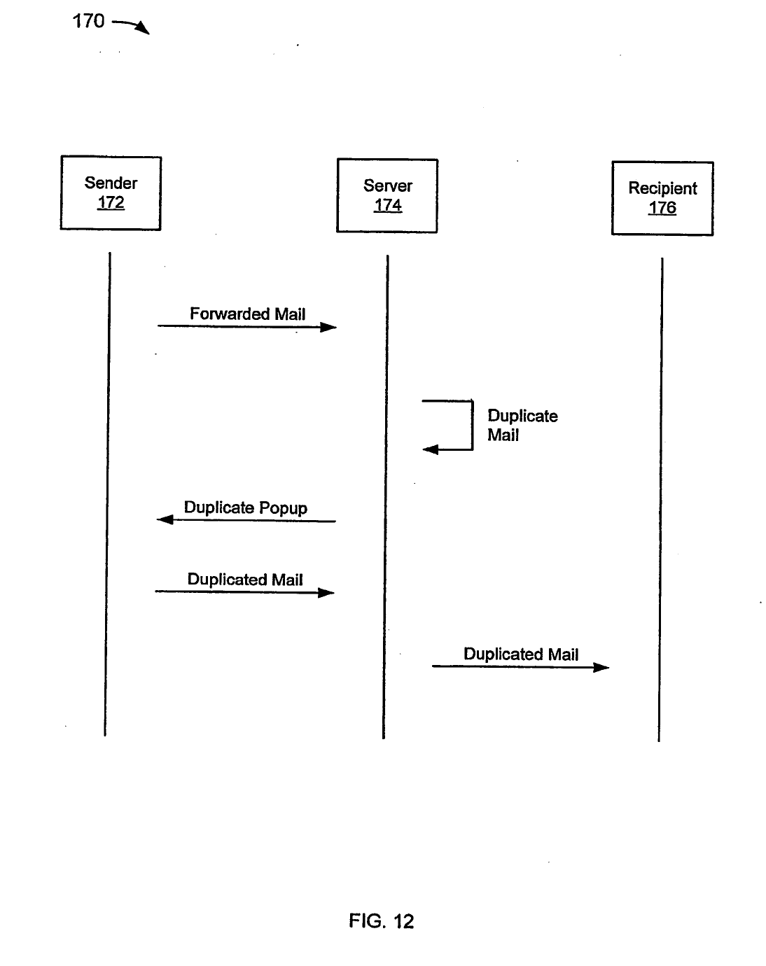

FIG. 12 depicts an example of an email transaction. FIG. 12 includes a system 170. The system 170 includes a sender 172, a server 174, and a recipient 176.

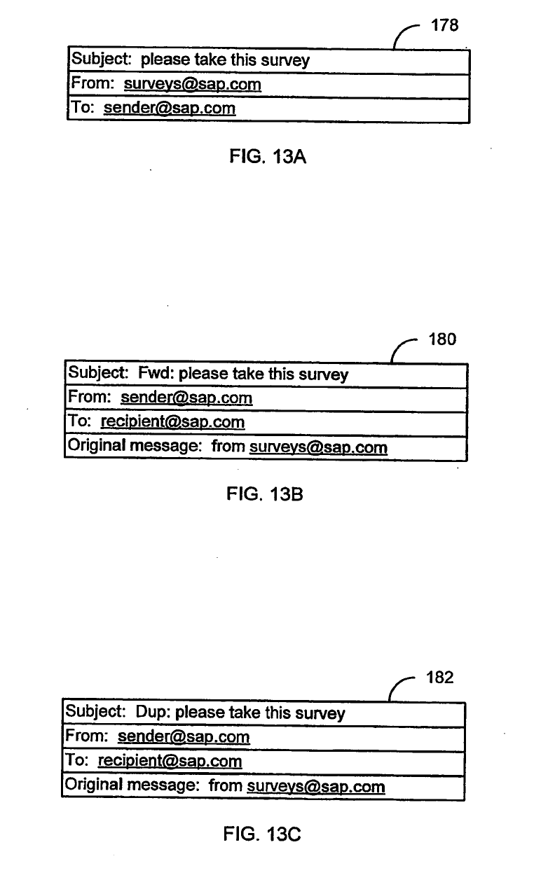

The mail, as initially received by the sender 172, may have been from a distribution list. FIG. 13A depicts an example of header information 178 that could have come from a distribution list. In the example of FIG. 13A, the fields of the header information 178 include “Subject: please take this survey”, “From: surveys@sap.com”, and “To: sender@sap.com”.

When the mail is forwarded, the header information may be changed. FIG. 13B depicts an example of header information 180 for the forwarded message. In the example of FIG. 13B, the fields of the header information 180 include “Subject: Fwd: please take this survey”, “From: sender@sap.com”, “To: recipient@sap.com”, and “Original message from: surveys@sap.com”. In this example, the header information is changed to insert “Fwd:” in the subject. Also, in this example, the header includes information about the original message, in this case the distribution list from which the email originated.

Referring once again to FIG. 12, the sender 172 forwards mail to the server 174. The server 174 may determine whether the message is forwarded by, for example, checking the subject for the term “Fwd:”. In this example, the message is indeed forwarded.

The server may then determine whether the forwarded message is a duplicate. This may be accomplished by, for example, checking the subscribers of the distribution list. In this example, the distribution list is “surveys@sap.com” and the sender and recipient are both subscribers of the distribution list. The server 174 may find the subscriber information locally in a “currently subscribed mailing lists” list that is maintained for each user, including the recipient 176. Alternatively, the server may check a distribution list manager or distribution list server to find out subscriber information. Since the recipient is a subscriber, the server 174 determines that the message is a duplicate.

In an embodiment, the server 174 may query the sender 172 when a potential duplicate is detected. This query may take the form of a popup window to which the sender 172 may respond. As illustrated in FIG. 12, the sender 172 may respond to the duplicate popup with a duplicate message, which the server 174 sends to the recipient 176.

Alternatively, the sender 172 may respond with a “send anyway” message, rather than sending the duplicate message. In this case, the server 174 may store the forwarded message until the sender 172 responds to the query. If the response is to “send anyway” the server 174 may convert the forwarded message to a duplicate message and send to the recipient 176. Otherwise, if the response is to not send, the server 174 may delete the message.

FIG. 13C depicts an example of header information 182 for the duplicate message. In the example of FIG. 13C, the fields of the header information 182 include “Subject:Dup: please take this survey”, “From: sender@sap.com”, “To: recipient@sap.com”, and “Original message from: surveys@sap.com”. In this example, the header information is changed from “Fwd:” in the subject to “Dup:” in the subject line. Since the subject line includes “Dup:”, the recipient 176 (FIG. 12) may adjust mail filtering rules to dispose of the duplicate message as desired.

While this invention has been described in terms of certain exemplary embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A method, comprising:
receiving a message forwarding a forwarded message;
comparing an intended recipient of the message to recipients of the forwarded message; and
marking the message as a duplicate.

2. The method of claim 1, wherein:
the recipients of the forwarded message include subscribers to a distribution list; and
providing a link to the forwarded message.

3. The method of claim 1, further comprising:
determining that the forwarded message originated from a distribution list.

4. The method of claim 1, further comprising:
querying a sender about sending the forward message.

5. The method of claim 1, further comprising:
relaying the message to the intended recipient.

6. The method of claim 1, further comprising:
packing the forwarded message.

7. The method of claim 1, further comprising:
cutting the forwarded message.

8. The method of claim 1, further comprising:
diverting the message.

9. The method of claim 1, wherein:
the method is performed by a processor responsive to a set of instructions, the set of instructions embodied in a machine-readable medium.

10. A device, comprising:
a processor;
memory, coupled to the processor, including:
a forward detection module configured to identify forwarded messages;
a duplicate detection module configured to identify an intended recipient of a message as a subscriber to a distribution list from which the forwarded message originated; and
a duplicate message modification module configured to mark a message forwarding the forwarded message.

11. The device of claim 10, further comprising:
a distribution list manager.

12. The device of claim 11, wherein:
the distribution list manager further includes a distribution list server.

13. The device of claim 11, wherein:
the distribution list manager further includes a list of subscribers to the distribution list from which the forwarded message originated.

14. The device of claim 10, further comprising:
a query generator configured to query a sender of the forwarded message as to whether to send the forwarded message even though the forwarded message has probably already been received by the intended recipient.

15. The device of claim 10, further comprising:
a mail server.

16. A method, comprising:
receiving a forwarded message;
comparing an intended recipient of the message to recipients of the forwarded message, including recipients in one or more distribution lists of the forwarded message;
querying a sender of the forwarded message to determine if the sender still wants to send the forwarded message;
discarding the forwarded message if the sender does not want to send the forwarded message responsive to the querying, and
marking the forwarded message as a duplicate if the sender does want to send the forwarded message.

17. The method of claim 16, further comprising:
determining that the forwarded message originated from one of the distribution lists.

18. The method of claim 16, further comprising:
sending the marked message to the intended recipient.

19. The method of claim 16, further comprising:
diverting duplicate messages.

20. The method of claim 16, further comprising:
checking at a client if the forwarded message was previously received.
